(19) United States
(12) Patent Application Publication
(10) Pub. No.: US 2026/0346221 A1
(43) Pub. Date: Nov. 5, 2026

(54) GAS-SOLID CO-CURRENT DOWNFLOW FLUIDISED BED REACTOR WITH HOMOGENEOUS FLOW

(71) Applicant: IFP Energies Nouvelles, Rueil-Malmaison (FR)

(72) Inventors: Sina TEBIANIAN, Rueil-Malmaison Cedex (FR); Jan VERSTRAETE, Rueil-Malmaison Cedex (FR)

(73) Assignee: IFP Energies Nouvelles, Rueil-Malmaison (FR)

(21) Appl. No.: 19/120,350

(22) PCT Filed: Oct. 2, 2023
(86) PCT No.: PCT/EP2023/077201

§ 371 Date: Apr. 11, 2025

(30) Foreign Application Priority Data
Oct. 13, 2022 (FR) FR2210519

(51) Int. Cl. B01J 8/24; B01J 8/00; B01J 8/18; C10G 11/18

(52) U.S. Cl. CPC B01J 8/24; B01J 8/003; B01J 8/008; B01J 8/1818; B01J 8/1872; B01J 8/1881; C10G 11/18; B01J 2208/00752; B01J 2208/0084; B01J 2208/00938

(57) ABSTRACT

Apparatus and process for cocurrent gas-solid downflow fluid catalytic cracking comprising/using: a pipe (1) suitable for transporting a downward flow (4) of catalyst particles; a mixing chamber (2) connected to the pipe (1) and suitable for being fed via the pipe with a downward flow, the mixing chamber comprising an internal wall, at least one first injector (5) for injecting hydrocarbon feedstock (6); a cocurrent gas-solid downflow fluidized bed reactor (3) connected to the mixing chamber and suitable for being fed via the mixing chamber with a mixture comprising catalyst particles and hydrocarbon feedstock, the cocurrent gas-solid downflow fluidized bed reactor comprising an internal wall, wherein the internal wall of the mixing chamber and/or of the cocurrent gas-solid downflow fluidized bed reactor comprises one or more obstacles (9).

### TECHNICAL FIELD

The invention relates to the field of refining and petrochemistry and processes and units for the chemical transformation of petroleum products, notably hydrocarbon cuts, by fluid catalytic cracking (FCC) for the production of light olefins (i.e. olefins comprising between 2 and 4 carbon atoms), and more particularly ethylene and propylene, and also aromatics (e.g. BTX), and more particularly para-xylene.

### PRIOR ART

The invention resides in improving the design of the established flow zone in cocurrent gas-solid downflow fluidized bed reactors (“downers” or “downflow reactors”), referred to hereinafter as downflow reactors, used for example for high severity catalytic cracking (HS-FCC).

Ethylene, propylene, butene, butadiene and aromatics such as benzene, toluene and xylene (BTX) represent the base products for the petrochemical industry. These products are generally obtained by catalytic reforming and/or thermal cracking (steam cracking) of hydrocarbons such as naphtha, kerosene or gas oil. These compounds are also obtained by fluid catalytic cracking (FCC) of hydrocarbons, such as a vacuum distillate (VD, or VGO for vacuum gas oil) and/or a (vacuum or atmospheric) residue from the distillation of hydrocarbons and/or naphtha, gas oils, and full crudes.

The high severity catalytic cracking (HS-FCC) process is aimed at increasing the yields of propylene and ethylene via high-temperature reaction conditions, very short contact times (e.g. ~1 s), and high ratios between the mass flow rate C of catalyst and the mass flow rate O of feedstock (C/O).

The disadvantages associated with a conventional cocurrent gas-solid upflow fluidized bed FCC reactor (or “riser”), such as backmixing and the accumulation of catalyst in the vicinity of the wall resulting in overcracking of the hydrocarbons and excessive formation of coke, hydrogen, methane and ethane, do not make it possible to promote the production of olefins under high severity conditions.

In order to overcome these disadvantages, the HS-FCC process uses a downflow reactor, in which the catalyst and the feedstock are set in motion under the effect of gravity with a flow that approximates that of plug flow. The downward gas-solid flow in a reactor avoids the backmixing and overcracking of the products, while the use of high C/O ratios ensures the predominance of the catalytic reactions. The high temperature promotes the formation of reaction intermediates such as light olefins, while a controlled and short contact time avoids the side reactions that are responsible for the consumption of such intermediates.

However, the downward gas-solid flow exhibits a number of major technological challenges, of which one significant challenge corresponds to the flow and the mixing within the established flow section of the reactor. Specifically, the flow of catalyst in a downflow reactor, especially with a high mass flow of solid (e.g. between 400-800 kg/m²s), is characterized by a flat solids concentration profile in the central zone and an annular zone in the vicinity of the wall where the concentration and flow of particles are higher. This segregation is the result of the low-velocity condition of the gas at the wall (no-slip condition) which produces a weak drag force on the particles resulting in clustering phenomena between the particles. This phenomenon is well described in the literature (Zhu et al., The Canadian Journal of Chemical Engineering, Volume 73 (1995), p. 662-677; Sun et al., Powder Technology, Vol. 370 (2020), p. 184-196). However, this segregation leads to a lower concentration of catalyst in the center of the reactor, thus reducing the reaction rates and the overall performance obtained at the reactor outlet.

Patent FR 2 753 453 B1 describes a downflow cracking reactor comprising a zone for bringing the hydrocarbons into contact with the catalyst, consisting of: a mixing chamber having a maximum cross section S2, placed in communication with means for supplying regenerated catalyst via an upper orifice defining a catalyst flow area S1; and a reaction zone having a maximum cross section S4, placed in communication with the mixing chamber via an intermediate orifice having a cross section S3, in which reactor the ratios S2/S1 and S2/S3 are between 1.5 and 8.

U.S. Pat. Nos. 10,889,768 B2 and 10,767,117 B2 describe systems and processes for producing petrochemical products (e.g. ethylene and other olefins), from hydrocarbon feedstocks (e.g. crude oil) in high severity fluid catalytic cracking (HS-FCC) units.

Patent application US 2022/0016589 A1 describes a downflow reactor comprising annular distribution and mixing baffles.

### SUMMARY OF THE INVENTION

Within the above-described context, a first objective of the present invention is to overcome the problems of the prior art and to provide an apparatus for cocurrent gas-solid downflow fluid catalytic cracking with homogeneous catalyst flow, i.e. in which the concentration of solid in the cross section of the reactor is substantially uniform. Specifically, the apparatus according to the invention makes it possible to obtain a homogeneous catalyst concentration between the central zone and the annular zone (i.e. in the vicinity of the wall) of the cocurrent gas-solid downflow reactor.

A second objective of the present invention is to provide an apparatus for cocurrent gas-solid downflow fluid catalytic cracking in which the solid concentration is increased in feedstock injection zones of the mixing chamber.

According to a first aspect, the abovementioned objectives, along with other advantages, are achieved by an apparatus for cocurrent gas-solid downflow fluid catalytic cracking comprising, from top to bottom:
a pipe suitable for transporting a downward flow of catalyst particles;
a mixing chamber connected to the pipe and suitable for being fed via the pipe with a downward flow, the mixing chamber comprising an internal wall and at least one first injector for injecting hydrocarbon feedstock;
a cocurrent gas-solid downflow fluidized bed reactor connected to the mixing chamber and suitable for being fed via the mixing chamber with a mixture comprising catalyst particles and hydrocarbon feedstock, the cocurrent gas-solid downflow fluidized bed reactor comprising an internal wall;
wherein the internal wall of the mixing chamber and/or of the cocurrent gas-solid downflow fluidized bed reactor comprises one or more discontinuous obstacles.

Advantageously, the plurality of obstacles is suitable for homogenizing the concentration of catalyst particles. Advantageously, the obstacles are suitable for deflecting (the trajectory of) catalyst particles toward the interior of the mixing chamber and/or of the cocurrent gas-solid downflow fluidized bed reactor, and/or toward the feedstock injection zones (i.e. in the vicinity of the first injector for injecting hydrocarbon feedstock).

According to one or more embodiments, the obstacles are suitable for distributing catalyst particles substantially toward the interior of the mixing chamber and/or of the cocurrent gas-solid downflow fluidized bed reactor.

According to one or more embodiments, the obstacles comprise an oblique upper surface that descends inwardly, i.e. toward the center of the reactor.

According to one or more embodiments, the obstacles are suitable for preventing the accumulation of catalyst particles on the obstacles.

According to one or more embodiments, the obstacles are suitable for distributing catalyst particles along the wall of the mixing chamber.

According to one or more embodiments, the obstacles comprise an oblique and laterally-descending upper surface.

According to one or more embodiments, the obstacles are prismatic, cylindrical, pyramidal, conical and/or frustoconical in form.

According to one or more embodiments, obstacles are arranged in the mixing chamber upstream of the at least one first injector.

According to one or more embodiments, obstacles are positioned in the downflow reactor at an axial distance Hi from the mixing chamber of between 0*L and 0.9*L, L being the length of the cocurrent gas-solid downflow fluidized bed reactor.

According to one or more embodiments, the apparatus comprises at least one row of obstacles arranged at a predetermined height of the internal wall of the mixing chamber and/or of the downflow reactor.

According to one or more embodiments, the perimeter of the internal wall of the mixing chamber and/or of the downflow reactor, occupied by the row of obstacles, is between 15% and 80%.

According to one or more embodiments, the row of obstacles reduces the flow area of the internal wall of the mixing chamber and/or of the downflow reactor by 1% to 35% and preferably by 5% to 20%.

According to one or more embodiments, the row of obstacles in the mixing chamber comprises between 2 and 24 obstacles, and/or the row of obstacles in the downflow reactor comprises between 2 and 24 obstacles.

According to one or more embodiments, the radial position of the obstacles of one row of obstacles is in a separation space between the radial position of two adjacent obstacles of an adjacent row of obstacles.

According to a second aspect, the abovementioned objectives, along with other advantages, are achieved by a process for cocurrent gas-solid downflow fluid catalytic cracking, comprising the following steps:
transporting a downward flow of catalyst particles in a pipe;
feeding a mixing chamber via the pipe with a downward flow, the mixing chamber comprising an internal wall and at least one first injector for injecting hydrocarbon feedstock;
feeding a cocurrent gas-solid downflow fluidized bed reactor via the mixing chamber with a mixture comprising catalyst particles and hydrocarbon feedstock, the cocurrent gas-solid downflow fluidized bed reactor comprising an internal wall; and
at least partially cracking the hydrocarbon feedstock in the presence of the catalyst particles in the cocurrent gas-solid downflow fluidized bed reactor, in order to produce an effluent comprising at least partially coked catalyst and gaseous cracking products,
wherein the internal wall of the mixing chamber and/or of the cocurrent gas-solid downflow fluidized bed reactor comprises a plurality of obstacles.

Other features and advantages of the invention of the aforementioned aspects will become apparent on reading the following description of non-limiting exemplary embodiments, with reference to the appended figures described below.

### LIST OF THE FIGURES

FIG. 1 represents an FCC apparatus according to one or more embodiments of the present invention comprising obstacles for homogenization of the catalyst flow.

FIG. 2 shows 3D views of an FCC apparatus according to one or more embodiments of the present invention comprising a plurality of rows of obstacles for the homogenization of the catalyst flow.

FIG. 3 shows 3D views of a layout A of a reference FCC apparatus, and of a layout B of an FCC apparatus according to one or more embodiments of the present invention comprising three rows of obstacles.

FIG. 4 shows 3D views of layouts A and B of the volume fraction of the catalyst averaged over time in the reference FCC apparatus of FIG. 3, and in the FCC apparatus according to the invention of FIG. 3, respectively.

FIG. 5 shows the radial profiles A and B of the fraction of the solid and of the mass flow of the solid at 2.8 m below the injectors of the reference FCC apparatus of FIG. 3, and of the FCC apparatus of the invention of FIG. 3, respectively.

### DETAILED DESCRIPTION OF THE INVENTION

Embodiments according to the aforementioned aspects will now be described in detail. The following detailed description discloses numerous specific details in order to provide a deeper understanding of the apparatus and process according to the present invention. However, it will be apparent to those skilled in the art that the apparatus can be implemented without these specific details. In other cases, well-known features have not been described in detail in order to avoid unnecessarily complicating the description.

In the present description, the term “comprise” is synonymous with (means the same thing as) “have”, “include” and “contain”, and is inclusive or open-ended and does not exclude other elements that are not stated. It is understood that the term “to comprise” includes the exclusive and closed term “to consist of”. In addition, in the present description, the terms “essentially” or “substantially” or “approximately” correspond to an approximation of +10%, preferably of +5%, very preferably of +1%.

The invention relates to an apparatus and to a process for fluid catalytic cracking for the chemical transformation of petroleum products (FCC), used for example for high severity catalytic cracking (HS-FCC).

An FCC unit generally treats a heavy cut obtained from the vacuum distilation unit, such as a vacuum gas oil or a vacuum residue, or else an atmospheric residue, alone or as a mixture. An FCC unit can also treat lighter cuts such as a gasoline cut or a gas oil cut, alone or as a mixture. It is also possible to treat a mixture of light and heavy cuts, or else a whole crude. In order to increase the propylene and ethylene yields by using high severity reaction conditions (high temperature, very short contact times, high C/O ratios between the flow rate C of catalyst and the flow rate O of feedstock), the catalytic cracking apparatuses and processes generally use a cocurrent gas-solid downflow fluidized bed reactor (“downer” or “downflow reactor”), hereinafter referred to as a downflow reactor.

However, the downward gas-solid flow may exhibit a number of technological challenges, including achieving homogeneous flow and mixing in the established flow section of the downflow reactor.

In order to overcome these disadvantages, improvements to the downflow reactor technology described in the patent FR 2 753 453 B1 have been identified in order to respond to the challenge set out above, through the use of obstaces which may be inserted in the mixing chamber or downstream of the mixing chamber, i.e. in the downflow reactor.

### The apparatus according to the invention

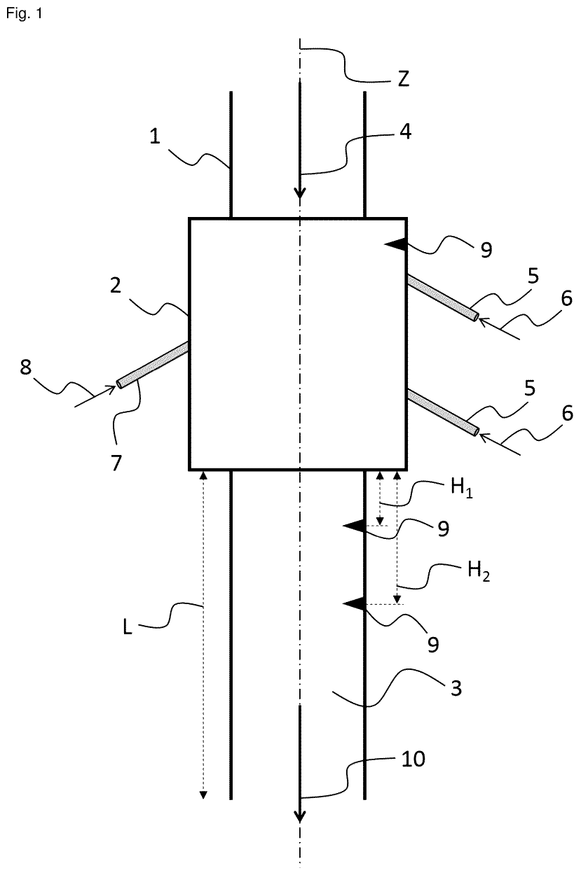

With reference to FIG. 1, the device according to one or more embodiments of the present invention comprises, from top to bottom:
a pipe 1;
a mixing chamber 2; and
a downflow reactor 3.

The pipe 1 is suitable for feeding the mixing chamber 2 with solid catalyst (particles). The pipe 1 mainly transports solid, and also a fluidizing gas entrained by the downward flowing solid. The pipe 1 has a flow like a standpipe, well known to those skilled in the art.

The mixing chamber 2 is connected to the pipe 1, comprises a side/vertical wall defining a central/vertical axis Z, and is suitable for feeding the downflow reactor 3 with a mixture comprising catalyst particles, a hydrocarbon feedstock and optionally a diluent.

The downflow reactor 3 is connected to the mixing chamber 2 and is suitable for at least partially cracking the hydrocarbon feedstock in the presence of the catalyst particles in order to produce an effluent comprising at least partially coked catalyst and gaseous cracking products, and optionally unconverted vaporized feedstock.

Specifically, with reference to FIG. 1, the pipe 1 feeds the mixing chamber 2 with a downward flow 4 of (hot) catalyst particles, the mixing chamber 2 comprising a plurality of first injectors 5 for injecting hydrocarbon feedstock 6. According to one or more embodiments, the first injector(s) 5 is/are suitable for injecting diluent (e.g. steam) with the feedstock. According to one or more embodiments, the mixing chamber 2 comprises one or more second injectors 7 for injecting diluent 8. In the mixing chamber 2, the downward flow 4 comes into contact with the hydrocarbon feedstock 6 atomized by means of the first injector(s) 5 and optionally with diluent 8 introduced for example by the second injector(s) 7.

Advantageously, the injection of diluent 8 makes it possible to reduce the partial pressure of the hydrocarbon feedstock and to reduce side reactions. Advantageously, the injection of diluent 8 makes it possible to improve the atomization of the hydrocarbon feedstock 6. According to one or more embodiments, the diluent 8 is chosen from the group consisting of steam, nitrogen, CO2, light hydrocarbons (e.g. C1-C5 compounds) and combustion flue gases. According to one or more embodiments, the diluent 8 comprises or consists of steam.

According to one or more embodiments, the pipe 1 has a geometry with a constant cross section, such as cylindrical, square, rectangular or hexagonal, or with a variable cross section, such as truncated pyramidal or frustoconical, or a combination of the various geometrical forms. According to one or more embodiments, the pipe 1 is cylindrical in form and optionally of variable diameter. According to one or more embodiments, the pipe 1 is at least partially frustoconical in form. According to one or more embodiments, the pipe 1 comprises (in the direction of flow of the solid catalyst): a cylindrical portion, the diameter of which is for example chosen in order to obtain a flow of solid of 100 to 800 kg/(m²s) and preferably between 300 to 600 kg/(m²s); a frustoconical (“narrowing”) portion adjacent to the mixing chamber 2, the diameter of which decreases, for example in order to achieve a flow of solid, without taking the internals into account, of between 400 and 2000 kg/(m²s) and preferably between 700 and 1500 kg/(m²s); and optionally a second cylindrical portion, the diameter of which is for example chosen in order to obtain a flow of solid, without taking the internals into account, of between 400 and 2000 kg/(m²s) and preferably between 700 and 1500 kg/(m²s).

According to one or more embodiments, the mixing chamber 2 has a geometry with a constant cross section, such as cylindrical, square, rectangular or hexagonal, or with a variable cross section, such as truncated pyrimidal or frustoconical, or a combination of the various geometrical forms. According to one or more embodiments, the mixing chamber 2 is cylindrical in form and optionally of variable diameter. According to one or more embodiments, the mixing chamber 2 is at least partially frustoconical in form. According to one or more embodiments, the mixing chamber 2 comprises an upper cross-sectional boundary S1 connecting the mixing chamber 2 to the pipe 1 and a lower cross-sectional boundary S2 connecting the mixing chamber 2 to the downflow reactor 3, the ratio S1/S2 being less than 0.9 and preferably less than 0.7. According to one or more embodiments, the ratio S1/S2 is between 0.4 and 0.9, preferably between 0.5 and 0.7.

According to one or more embodiments, the mixing chamber 2 comprises between 2 and 12 first injectors 5, preferably between 3 and 8 first injectors 5.

According to one or more embodiments, the mixing chamber 2 comprises between 2 and 12 second injectors 7, preferably between 3 and 8 second injectors 7.

According to one or more embodiments, the injectors 5 and/or 7 are inclined upward or downward or are arranged substantially horizontally.

According to one or more embodiments, the injectors 5 and/or 7 are inclined upward, for example with an angle of between 10° and 45° relative to the horizontal.

With reference to FIG. 1, according to one or more embodiments, first injectors 5 and/or second injectors 7 are arranged in one or more horizontal rows, i.e. rows that are perpendicular to the central/vertical axis Z of the mixing chamber 2. According to one or more embodiments, second injectors 7 are arranged below (for example, a row of) first injectors 5. According to one or more embodiments, second injectors 7 are arranged between two rows of first injectors 5.

According to one or more embodiments, the radial position of the second injectors 7 is in a separation space between the adjacent radial positions of two first injectors 5. According to one or more embodiments, the second injectors 7 are positioned substantially at half the angle of separation of two first injectors 5.

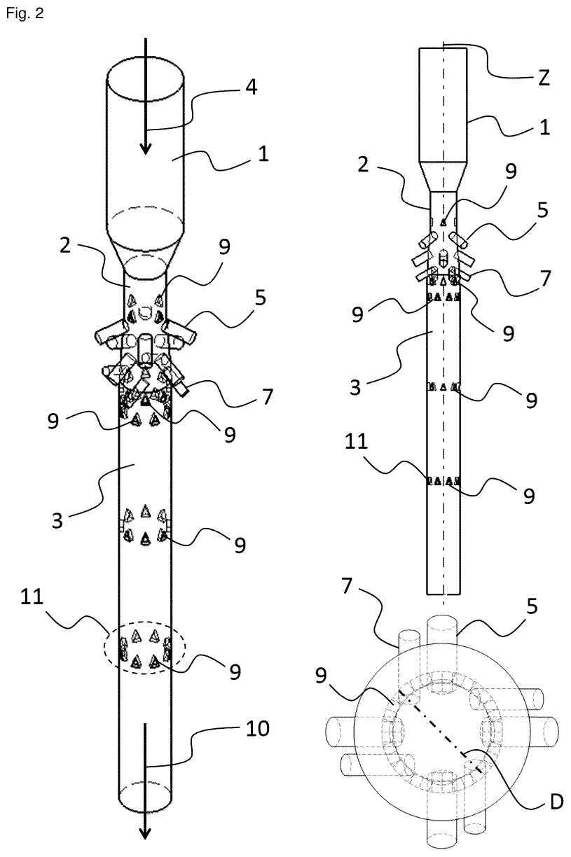

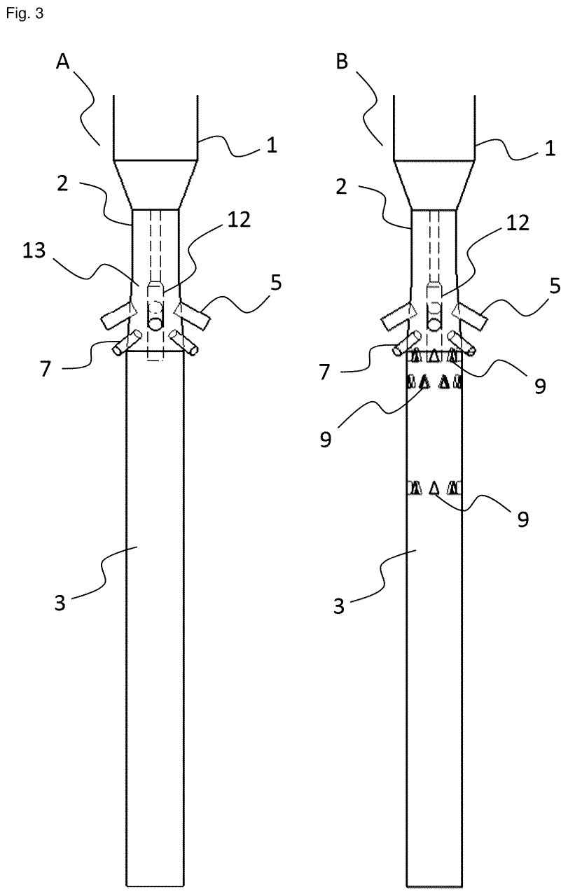

With reference to FIGS. 2 and 3, according to one or more embodiments, at least one first injector 5 and/or at least one second injector 7 is rotated by an angle of between 0° and 45°, and preferably of between 10° and 20°, relative to the radial direction of the diameter D of the mixing chamber 2, i.e., the projection of the axis of the injectors 7 on a horizontal plane forms said angle, with the radial direction of the diameter D of the mixing chamber 2, which is perpendicular to the central/vertical axis Z.

With reference to FIG. 1, the mixing chamber 2 feeds the downflow reactor 3 with a mixture of hydrocarbon feedstock 6, catalyst particles and optionally diluent 8. Advantageously, the hydrocarbon feedstock 6 and the catalyst particles give rise to cracking reactions which are completed in the downflow reactor 3 of length L (along the central/vertical axis Z) to produce a hydrocarbon effluent comprising cracked products, spent catalyst and potentially a portion of unreacted hydrocarbon feedstock. The length L of a downflow reactor 3 is typically between 2 m and 25 m.

According to one or more embodiments, the downflow reactor 3 has a geometry with a constant cross section, such as cylindrical, square, rectangular or hexagonal, and preferably cylindrical. According to one or more embodiments, the downflow reactor 3 is cylindrical in form and optionally of variable diameter.

According to one or more embodiments, the diameter of the downflow reactor 3 is defined such that the superficial velocity of the gas passing through it is between 2 m/s and 26 m/s, preferentially between 6 m/s and 16 m/s.

According to the invention, the internal wall of the mixing chamber 2 and/or of the downflow reactor 3 comprises one or more obstacles 9. Advantageously, the obstacles 9 are suitable for homogenizing the concentration of catalyst particles. Specifically, the obstacles 9 make it possible to redistribute the catalyst particles which may accumulate close to the walls (e.g. of the mixing chamber 2 and the downflow reactor 3).

According to the invention, the radial position of the at least one obstacle 9 on the internal wall of the mixing chamber 2 and/or the downflow reactor 3 is discontinuous. In the present application, the term “discontinuous obstacle” means that the perimeter of the internal wall of the mixing chamber 2 and/or of the downflow reactor 3 occupied by the obstacle 9 is less than 90%, preferably less than 80%, very preferably less than 70%. According to one or more embodiments, the perimeter of the internal wall of the mixing chamber 2 and/or of the downflow reactor 3 occupied by the obstacle 9 is between 15% and 80%, preferably between 30% and 70%, very preferably between 40% and 60%. Thus, the at least one obstacle 9 is not of continuous form, i.e. annular form.

The obstacles 9 may be of varied geometrical forms. According to one or more embodiments, the obstacles 9 are cubic, tetrahedral, parallelepipedal, prismatic (e.g. prism with a triangular, square, rectangular, hexagonal, circular or elliptical base), or pyramidal (e.g. pyramid with a triangular, square, rectangular, hexagonal, circular or elliptical base), or frustoconical in form, forming for example separate elements on the wall of the mixing chamber 2. According to one or more embodiments, the base is substantially perpendicular to the vertical axis Z.

According to one or more embodiments, the obstacles 9 are arranged to prevent the accumulation of catalyst particles on the obstacles 9. According to one or more embodiments, the obstacles 9 comprise a lower part (lower end surface) that is wider than the upper part (upper end surface).

According to one or more embodiments, the obstacles 9 are arranged to distribute the catalyst particles toward feedstock injection zones of the mixing chamber 2, zones which are more concentrated in hydrocarbons. According to one or more embodiments, the obstacles 9 comprise an oblique upper surface that descends laterally, i.e. along the wall of the mixing chamber 2.

According to one or more embodiments, the obstacles 9 are arranged to distribute the catalyst particles substantially toward the inside (e.g. toward the vertical axis Z), a zone which is more concentrated in hydrocarbons. According to one or more embodiments, the obstacles 9 comprise an oblique upper surface that descends from the outside towards the inside.

According to one or more embodiments, obstacles 9 are positioned in the mixing chamber 2 upstream of the at least one first injector 5 for injecting hydrocarbon feedstock 6 and/or of the at least one second injector 7 for injecting diluent 8. Advantageously, the obstacles 9 make it possible to direct the catalyst particles toward the injectors and increase the contact, in particular with the hydrocarbon feedstock 6. According to one or more embodiments, the radial position of the obstacles 9 in the mixing chamber 2 is in a separation space between the adjacent radial positions of two (e.g. first) injectors.

According to one or more embodiments, obstacles 9 are positioned downstream of the at least one first injector 5 for injecting hydrocarbon feedstock 6 and/or of the at least one second injector 7 for injecting diluent 8. According to one or more embodiments, obstacles 9 are positioned downstream of the at least one first or second injector at an axial distance of between 0*L and 0.3*L, and preferably between 0.01*L and 0.1*L.

According to one or more embodiments, obstacles 9 are positioned in the downflow reactor 3 at an axial distance Hᵢ (e.g. H₁, H₂, etc.) from the mixing chamber 2 of between 0*L and 0.9*L, preferably between 0.01*L and 0.6*L, for example between 0.01*L and 0.4*L.

According to one or more embodiments, the rows 11 of obstacles are spaced apart by a distance of between 0.05*L and 0.4*L. With reference to FIG. 2, according to one or more embodiments, the apparatus according to the invention comprises at least one row of obstacles 9, relative to the central/vertical axis Z, arranged at a predetermined height of the internal wall of mixing chamber 2 and/or of the downflow reactor 3. According to one or more embodiments, the obstacles 9 of the row 11 of obstacles, thus arranged in a “string”, are positioned substantially equidistantly from one another. Advantageously, a row 11 of obstacles comprises (all) the obstacles 9 of a horizontal plane perpendicular to the central/vertical axis Z.

According to one or more embodiments, the perimeter of the internal wall of the mixing chamber 2 and/or of the downflow reactor 3, occupied by the row 11 of obstacles, is between 15% and 80% and preferably between 30% and 70%, for instance 40% to 60%.

According to one or more embodiments, the row 11 of obstacles reduces the flow area of the internal wall of the mixing chamber 2 and/or of the downflow reactor 3 by 1% to 35% and preferably by 5% to 20%, for instance by 10% to 20%.

According to one or more embodiments, a row 11 of obstacles comprises at least 2 obstacles 9, for example between 2 and 24 obstacles 9, preferably between 4 and 12 obstacles 9.

According to one or more embodiments, a row 11 of obstacles in the mixing chamber 2 comprises at least 2 obstacles 9, for example between 2 and 24 obstacles 9, preferably between 4 and 12 obstacles 9, for instance 4 obstacles 9.

According to one or more embodiments, the number of obstacles 9 of a row 11 of obstacles in the mixing chamber 2 is an integer multiple of the number of first injectors 5. According to one or more embodiments, a row 11 of obstacles in the mixing chamber 2 comprises as many obstacles as there are first injectors 5.

According to one or more embodiments, a row 11 of obstacles in the downflow reactor 3 comprises at least 2 obstacles 9, for example between 2 and 24 obstacles 9, preferably between 3 and 12 obstacles 9, very preferably between 4 and 8 obstacles 9, for instance 8 obstacles 9.

According to one or more embodiments, the number of obstacles of a row 11 of obstacles in the downflow reactor 3 is an integer multiple of the number of first injectors 5. According to one or more embodiments, a row 11 of obstacles in the downflow reactor 3 comprises as many obstacles as there are first injectors 5.

According to one or more embodiments, the mixing chamber 2 comprises between 0 and 4 rows 11 of obstacles, such as 1 row 11 of obstacles preferably positioned above the (e.g. first) injectors.

According to one or more embodiments, a downflow reactor 3 comprises at least 1 row 11 of obstacles, for example between 1 and 10 rows 11 of obstacles, preferably between 2 and 8 rows 11 of obstacles, very preferably between 3 and 6 rows 11 of obstacles, for instance 3 rows 11 of obstacles.

According to one or more embodiments, the downflow reactor 3 comprises:
a first row 11 of obstacles positioned at an axial distance H₁ from the mixing chamber 2 of between 0*L and 0.9*L;
preferably a second row 11 of obstacles positioned at an axial distance from the first row 11 of obstacles of between 0.05*L and 0.4*L; and preferably a third row 11 of obstacles positioned at an axial distance from the preceding row 11 of obstacles of between 0.05*L and 0.4*L.

According to one or more embodiments, the mixing chamber 2 comprises 1 row 11 of obstacles preferably positioned above the (e.g. first) injectors, and the downflow reactor 3 comprises at least 1 row 11 of obstacles, for example between 1 and 10 rows 11 of obstacles, preferably between 2 and 8 rows 11 of obstacles, very preferably between 3 and 6 rows 11 of obstacles, for instance 3 rows 11 of obstacles, the distance between two rows preferably being between 0.05*L and 0.4*L.

According to one or more embodiments, the radial position of the obstacles 9 of a row 11 of obstacles is in a separation space between the radial position of two adjacent obstacles 9 of an adjacent row 11 of obstacles, i.e., each row 11 of obstacles has a rotation (about the vertical axis Z) relative to an adjacent row 11 of obstacles. According to one or more embodiments, the radial position of the obstacles 9 of a row 11 of obstacles has a rotation through an angle of between 10° and 35°, preferably between 15° and 30°, relative to the radial position of the obstacles 9 of an adjacent row 11 of obstacles, and preferably through an angle of 180°/N, with N the number of obstacles in a row. According to one or more embodiments, the rows 11 of obstacles are positioned relative to one another so as to cover together the entire perimeter of the internal wall of the mixing chamber 2 and/or of the downflow reactor 3, when viewed along the vertical axis Z.

Moreover, compared to crown-type internals that can significantly reduce the flow area and increase the gas velocity in the central zone of the downflow reactor 3, which can produce a parabolic flow profile far removed from plug flow, the row(s) 11 of obstacles according to the invention makes it possible to homogenize the flow of the catalyst without significantly reducing the flow area of the downflow reactor 3.

With reference to FIG. 3, according to one or more embodiments, at least part of the mixing chamber 2 comprises a central plug 12 arranged substantially along the central/vertical axis Z and defining an annular orifice 13 in the mixing chamber 2, through which the catalyst particles discharge and/or flow into the mixing chamber 2.

### The Catalyst

The catalyst is a solid catalyst (e.g. particles with a density, size and shape of the grains chosen for use in a fluidized bed). The densities, sizes and shapes of the catalysts for fluidized beds are known to a person skilled in the art and will not be described further. The catalyst may be any type of catalytic cracking catalyst.

According to one or more embodiments, the catalyst is an FCC catalyst, containing, for example, what is commonly called a matrix made of clay, of silica or of silica-alumina, optionally of binder, and/or of zeolite, for example from 15% to 70% by weight of zeolite relative to the weight of the catalyst, preferably a zeolite Y and/or a zeolite ZSM-5. According to one or more embodiments, the catalyst comprises a zeolite ZSM-5. According to one or more embodiments, the grain density of the catalyst is between 1000 kg/m³ and 2000 kg/m³. According to one or more embodiments, the grain density of the catalyst is between 1250 kg/m³ and 1750 kg/m³.

According to one or more embodiments, the catalyst comprises at least one binder (e.g. from 30% to 85% by weight) selected from alumina, silica, silica-alumina, magnesia, titanium oxide, zirconia, clays and boron oxide, alone or in a mixture, and preferably from silica, silica-alumina and clays, alone or in a mixture.

According to one or more embodiments, the catalyst comprises at least one doping element (e.g. from 0 to 10% by weight) selected from phosphorus, magnesium, sodium, potassium, calcium, iron, boron, manganese, lanthanum, cerium, titanium, tungsten, molybdenum, copper, zirconium and gallium, alone or in a mixture.

According to one or more embodiments, the catalyst comprises and/or consists of zeolite, such as ZSM-5, which is optionally doped.

### The Feedstock

According to one or more embodiments, the hydrocarbon feedstock 6 is a heavy feedstock, characterized by an initial boiling point close to 340 °C, often above 380 °C, such as a heavy cut, for example obtained from a vacuum distillation unit, such as vacuum gas oil (VGO)/vacuum distillate or a vacuum residue, an atmospheric residue, vacuum gas oil obtained from a conversion unit, such as a coker gas oil (heavy coker gas oil (HCGO)) or a heavy cut obtained from an ebullated bed or entrained bed hydroconversion unit (such as H-Oil, LC-Fining, EST, VCC or Uniflex processes), a recycle stream from a hydrocracking step, alone or as a mixture.

According to one or more embodiments, the hydrocarbon feedstock 6 is a light feedstock, characterized by a final boiling point below 450 °C, often below 400 °C, such as a gasoline cut or a gas oil cut, for example obtained from an atmospheric distillation unit, or obtained from a conversion unit, such as a gasoline or a gas oil from a hydrocracking unit, or a gasoline or a gas oil from a coking unit or a gasoline or a gas oil from an ebullated bed or entrained bed hydroconversion unit (such as H-Oil, LC-Fining, EST, VCC or Uniflex processes), or a gasoline or a gas oil obtained from an FCC unit, or a recycle stream from the FCC unit concerned, alone or as a mixture. According to one or more embodiments, it is also possible to treat a mixture of light and heavy cuts, or else a whole crude.

On contact with the downward flow 4 of hot catalyst particles, the atomized hydrocarbon feedstock 6 vaporizes and endothermic cracking reactions take place along the downflow reactor 3, thus reducing the temperature and producing:
upgradable products (e.g. C1-C4 gas comprising olefins; a gasoline cut comprising aromatics);
optionally a light gas oil cut (light cycle oil (LCO));
optionally a heavy gas oil cut (heavy cycle oil (HCO));
optionally an oil in the form of slurry; and
optionally a solid residue (coke) adsorbed on the catalyst.

### The Process According to the Invention

The process according to the present invention comprises a catalytic cracking stage for the production of light olefins (and in particular ethylene and propylene), aromatics (and in particular benzene, toluene and xylenes), and gasoline (and optionally LCO, HCO and slurry), by catalytic cracking of the hydrocarbon feedstock 6 (fed via the first injector 5) through contact with the downward flow 4 of hot catalyst particles (fed via the pipe 1), and optionally the diluent 8 (fed via the second injector 7) in the mixing chamber 2 and then in the downflow reactor 3.

According to one or more embodiments, the downward flow 4 of the catalyst particles in the pipe 1 upstream of the mixing chamber 2 is in dense fluidized regime, preferably with a mass flow of greater than 200 kg/m²s, in order, for example, to preferably enable a regime with descending bubbles.

In the present patent application, the term “dense fluidized bed” means a gas-solid fluidized bed operating in homogeneous regime, in bubbling regime or in turbulent regime.

In the present patent application, the term “homogeneous fluidized bed” means a gas-solid fluidized bed, the gas velocity of which is between the minimum fluidization velocity and the minimum bubbling velocity. These velocities depend on the properties of the solid catalyst (density, size, shape of the grains, etc.). The fraction by volume of solid is between a value close to 0.45 and the maximum fraction by volume of solid corresponding to a non-fluidized fixed bed, generally close to 0.6.

In the present patent application, the term “bubbling fluidized bed” means a gas-solid fluidized bed, the gas velocity of which is between the minimum bubbling velocity and the velocity of transition to turbulent regime. These velocities depend on the properties of the solid catalyst (density, size, shape of the grains, etc.). The volume fraction of solid is between a value close to 0.35 and a value close to 0.45.

In the present patent application, the term “turbulent fluidized bed” means a gas-solid fluidized bed, the gas velocity of which is between the velocity of transition to turbulent regime and the transport velocity. The volume fraction of solid is between a value close to 0.25 and a value close to 0.35.

In the present patent application, the term “transport fluidized bed” means a gas-solid fluidized bed, the gas velocity of which is greater than the transport velocity. The volume fraction of solid is less than a value close to 0.25. In the present patent application, the term “transport velocity” corresponds to the velocity with which essentially all the solid is entrained by the gas.

According to one or more embodiments, the injectors 5 are suitable for atomizing the hydrocarbon feedstock 6 (liquid) and penetrating the catalyst stream.

According to one or more embodiments, the operating conditions of the pipe 1 and of the downflow reactor 3 are selected from the following conditions:
temperature (of reactor outlet) of between 520 °C and 750 °C and preferably below 650 °C;
1 absolute total pressure of between 0.1 MPa and 0.5 MPa;
weight ratio of catalyst 4 to hydrocarbon feedstock 6, C/O, of between 5 (kg/h)/(kg/h) and 35 (kg/h)/(kg/h) and preferably between 15 (kg/h)/(kg/h) and 30 (kg/h)/(kg/h);
contact time to between the hydrocarbon feedstock 6 and the catalyst of less than 10 seconds, preferably between 0.5 seconds and 4 seconds;
mass flow of catalyst particles of between 50 and 850 kg/(m²s), preferably between 400 and 750 kg/(m²s); and
the superficial gas velocity of between 2 m/s and 26 m/s, preferably between 6 m/s and 16 m/s.

In the present description, the contact time the is defined as the product of the solid volume fraction εₛ and the bed height Hₛ (e.g. reactor height L), divided by the superficial gas velocity sgv, this being integrated along the height of the bed, as defined below in the mathematical formula Math 1.

$${t}_{c} = {{\int }_{0}}^{{H}_{s}} \frac{{ε}_{s} {H}_{s}}{sgv} \qquad Math 1$$

According to one or more embodiments, an amount of diluent 8 (e.g. nitrogen and/or steam) is added to the feedstock to reduce the partial pressure of hydrocarbons in the feedstock and the diluant is introduced in an amount representing 0% or 0.1% to 40% by weight, preferably 1% to 35% by weight and preferably of between 1% and 30% by weight relative to the mass of hydrocarbon feedstock 6.

According to one or more embodiments, at the end of the catalytic cracking stage in the downflow reactor 3, the gaseous products and the catalyst, and optionally the unconverted vaporized feedstock, are separated in the gas/solid separator (not shown) containing a dense fluidized bed where the cracking reactions can continue.

According to one or more embodiments, the operating conditions of the separator are selected from the following conditions:
temperature (of reactor outlet) of between 500 °C and 750 °C, preferably between 550 °C and 700 °C, and even more preferably between 580 °C and 685 °C;
absolute total pressure of between 0.1 MPa and 0.5 MPa and preferably between 0.1 MPa and 0.4 MPa and preferably between 0.1 MPa and 0.3 MPa;
weight ratio of catalyst to feedstock (unconverted vaporized feedstock and gaseous products), C/O, of between 5 (kg/h)/(kg/h) and 40 (kg/h)/(kg/h);
contact time to between the feedstock and the catalyst of between 500 milliseconds (ms) and 10 seconds; and
partial pressure of the hydrocarbons in the feedstock (PPHfeedstock) of between 0.01 MPa and 0.3 MPa, preferably between 0.02 MPa and 0.2 MPa and preferably between 0.05 MPa and 0.15 MPa.

According to one or more embodiments, at the outlet of the separator, the coked catalyst is sent to an optional stripper (not shown) in order to strip the hydrocarbons that have remained adsorbed on the surface of the catalyst by means of a second diluent.

According to one or more embodiments, the operating conditions of the stripper are selected from the following conditions:
residence time of the catalyst in the stripper: between 10 seconds and 180 seconds, preferentially between 30 seconds and 120 seconds;
superficial gas velocity between the minimum fluidization velocity and the transition velocity to turbulent regime, for example between 0.01 m/s and 0.5 m/s, preferentially between 0.15 m/s and 0.4 m/s;
solid flow between 25 kg/m²s and 200 kg/m²s, preferentially between 50 kg/m²s and 150 kg/m²s and preferably between 50 kg/m²s and 100 kg/m²s;
temperature between 500 °C and 750 °C, preferentially between 550 °C and 650 °C;
absolute total pressure of between 0.1 MPa and 0.5 MPa and preferably between 0.1 MPa and 0.4 MPa and preferably between 0.1 MPa and 0.3 MPa;
solid volume fraction between 0.25 and 0.6, preferentially between 0.4 and 0.6.

According to one or more embodiments, at the outlet of the separator or stripper, the coked solid is transported to a regenerator (not shown) in which an air supply burns the coke off the catalyst to produce hot regenerated catalyst and combustion gases, it being possible for the hot regenerated catalyst to feed the downward flow 4 with hot catalyst particles.

According to one or more embodiments, the operating conditions of the regenerator are selected from the following conditions:
superficial gas velocity of between 0.1 m/s and 2 m/s, preferentially between 0.2 m/s and 1.5 m/s;
residence time of the catalyst of between 30 seconds and 20 minutes, preferentially between 1 minute and 10 minutes;
temperature between 500 °C and 840 °C, preferentially between 650 °C and 750 °C.

### Examples

With reference to FIG. 3, the flows in a reference apparatus A and an apparatus according to the invention B operating under non-reactive conditions were compared in order to study the hydrodynamics.

The reference apparatus A and the apparatus according to the invention B comprise:
a pipe 1, consisting of a cylindrical section, a narrowing cone and a cylindrical section;
a frustoconical mixing chamber 2 (S1/S2 being less than 1) comprising a central plug 12 defining an annular orifice 13;
a cylindrical downflow reactor 3 having a length of 4.07 m and an internal diameter of 0.42 m;
four first injectors 5 for injecting hydrocarbon feedstock 6, positioned countercurrent to the downward flow 3 of catalyst particles with an upward angle of 30° relative to the horizontal direction; and
four second injectors 7 for injecting diluent 8 (steam), positioned countercurrent to the downward flow 3 of catalyst particles with an upward angle of 30° relative to the horizontal direction.

The reference apparatus A has no obstacles positioned by the internal walls.

The apparatus according to the invention has three rows 11 of obstacles positioned by the wall of the downflow reactor 3. Each row 11 of obstacles includes 8 prisms of isosceles triangular cross section with a base of 0.07 m and a height of 0.096 m. In this example, the base of the prism is perpendicular to the vertical axis Z. The perimeter occupied by the obstacles 9 of a row 11 of obstacles is 46% of the total perimeter of the downflow reactor 3. The cross section occupied by the obstacles 9 of a row 11 of obstacles is 16% of the cross section of the downflow reactor 3.

The first row 11 of obstacles, the second row 11 of obstacles and the third row 11 of obstacles are positioned at a distance of 0.4 m, 0.6 m and 1.4 m from the first injectors 5 for injecting hydrocarbon feedstock 6, respectively. Each row 11 of obstacles has a rotation of 22.5° relative to the preceding row 11 of obstacles, in order in particular to direct the catalyst particles flowing between two obstacles 9 toward more dilute zones.

The configurations of the reference apparatus A and of the apparatus according to the invention B were simulated in CFD with the Barracuda© tool under the following operating conditions:
the catalyst flow is 607 kg/m²s;
the catalyst has a diameter d50 of 73 μm and a grain density of 1418 kg/m³ (i.e., group A of the Geldart classification);
the air flow rate of 1.85 kg/s exhibits a ratio of the first injectors 5 to the second injectors 7 of 70/30;
the first injectors 5 are positioned 0.2 m above the second injectors 7;
the angle of rotation between the first injectors 5 and the second injectors 7 is 45°;
the gas velocity at the outlet of the injectors is 90 m/s for the first injectors 5 and 76 m/s for the second injectors 7;
the flow is under ambient non-reactive conditions;
a central plug 12 is positioned at the center of the mixing chamber 2.

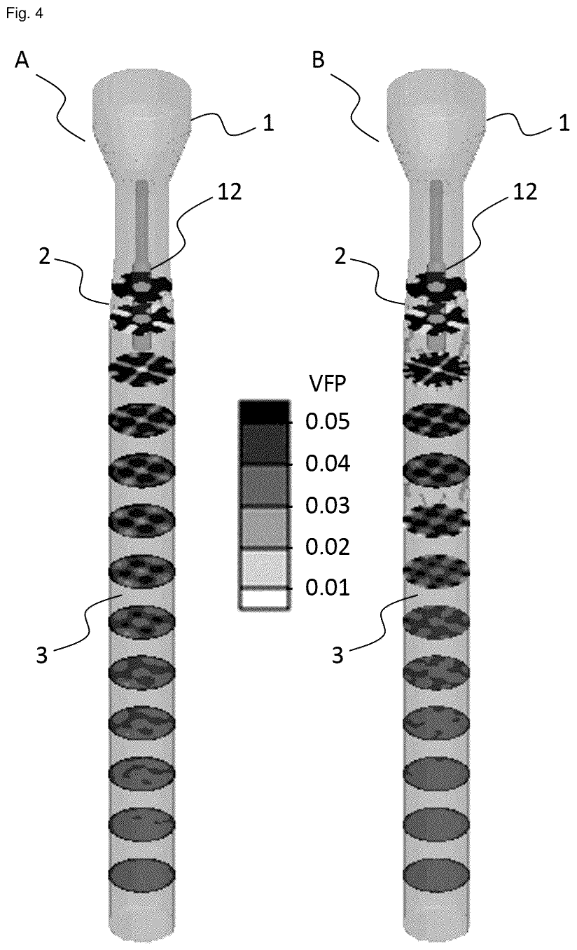

FIG. 4 presents the volume fraction of particles, denoted VFP, for the two configurations A and B of the reference apparatus A and of the apparatus according to the invention B, respectively, over 13 cross sections. The first two cross sections are respectively at the height of the first and second injectors 5 and 7, and the following cross sections are spaced 0.35 m apart.

Advantageously, the radial distribution of the solid throughout the downflow reactor 3 is always more homogeneous for the apparatus according to the invention B compared to the reference apparatus A. In addition, a high concentration of the solid in the vicinity of the wall can be noted for the reference apparatus A compared to the apparatus according to the invention B.

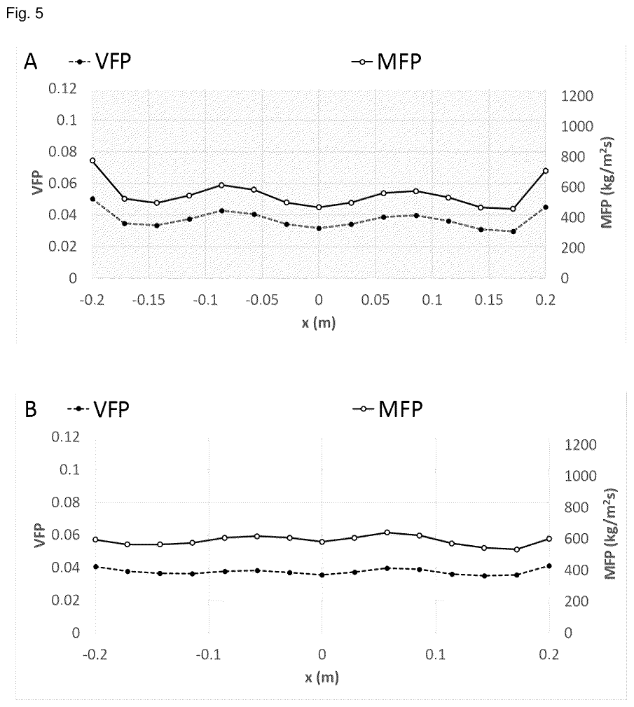

FIG. 5 shows the radial profiles A and B of the volume fraction of particles VFP, and of the mass flow of the particles, denoted MFP, of the reference apparatus A and of the apparatus according to the invention B of FIG. 3, respectively. The radial profiles A and B are produced in an x direction (perpendicular to the vertical axis Z) at a height of 2.8 m below the first injectors 5. It may be noted that the apparatus according to the invention B produces a more homogeneous radial profile B with a better phase distribution. The coefficient of variation of the values of volume fraction of particles VFP on these radial profiles A and B is 15% for the reference apparatus A and 5% for the apparatus according to invention B. Equivalently, the coefficient of variation of the values of mass flow of particles MFP for the profiles A and B is 16% for the reference apparatus A and 5% for the apparatus according to the invention B, which indicates a better dispersion of the catalyst over the cross section for the apparatus according to the invention B.

1. An apparatus for cocurrent gas-solid downflow fluid catalytic cracking comprising, from top to bottom:
a pipe (1) suitable for transporting a downward flow (4) of catalyst particles;
a mixing chamber (2) connected to the pipe (1) and suitable for being fed via the pipe (1) with a downward flow (4), the mixing chamber (2) comprising an internal wall, at least one first injector (5) for injecting hydrocarbon feedstock (6); and
a cocurrent gas-solid downflow fluidized bed reactor (3) connected to the mixing chamber (2) and suitable for being fed via the mixing chamber (2) with a mixture comprising catalyst particles and hydrocarbon feedstock, the cocurrent gas-solid downflow fluidized bed reactor (3) comprising an internal wall;
wherein the internal wall of the mixing chamber (2) and/or of the cocurrent gas-solid downflow fluidized bed reactor (3) comprises one or more discontinuous obstacles (9).

2. The apparatus as claimed in claim 1, wherein the obstacles (9) are suitable for distributing catalyst particles substantially toward the interior of the mixing chamber (2) and/or of the cocurrent gas-solid downflow fluidized bed reactor (3).

3. The apparatus as claimed in claim 1, wherein the obstacles (9) comprise an oblique and inwardly-descending upper surface.

4. The apparatus as claimed in claim 1, wherein the obstacles (9) are suitable for preventing the accumulation of catalyst particles on the obstacles (9).

5. The apparatus as claimed in claim 1, wherein the obstacles (9) are suitable for distributing catalyst particles along the wall of the mixing chamber (2).

6. The apparatus as claimed in claim 1, wherein the obstacles (9) comprise an oblique and laterally-descending upper surface.

7. The apparatus as claimed in claim 1, wherein the obstacles (9) are prismatic, cylindrical, pyramidal, conical and/or frustoconical in form.

8. The apparatus as claimed in claim 1, wherein obstacles (9) are arranged in the mixing chamber (2) upstream of the at least one first injector (5).

9. The apparatus as claimed in claim 1, wherein obstacles (9) are positioned in the downflow reactor (3) at an axial distance Hᵢ from the mixing chamber (2) of between 0*L and 0.9*L, L being the length of the cocurrent gas-solid downflow fluidized bed reactor (3).

10. The apparatus as claimed in claim 1, comprising at least one row of obstacles (11) arranged at a predetermined height of the internal wall of the mixing chamber (2) and/or of the downflow reactor (3).

11. The apparatus as claimed in claim 10, wherein the perimeter of the internal wall of the mixing chamber (2) and/or of the downflow reactor (3), occupied by the row of obstacles (11), is between 15% and 80%.

12. The apparatus as claimed in claim 10, wherein the row of obstacles (11) reduces the flow area of the internal wall of the mixing chamber (2) and/or of the downflow reactor (3) by 1% to 35%.

13. The apparatus as claimed in claim 10, wherein the row of obstacle units (11) in the mixing chamber (2) comprises between 2 and 24 obstacles (9), and/or the row of obstacles (11) in the downflow reactor (3) comprises between 2 and 24 obstacles (9).

14. The apparatus as claimed in claim 10, wherein the radial position of the obstacles (9) of one row (11) of obstacles is in a separation space between the radial position of two adjacent obstacles (9) of an adjacent row (11) of obstacles.

15. A process for cocurrent gas-solid downflow fluid catalytic cracking, comprising the following steps:
transporting a dense downward flow (4) of catalyst particles in a pipe (1);
feeding a mixing chamber (2) via the pipe (1) with a downward flow (4), the mixing chamber (2) comprising an internal wall and at least one first injector (5) for injecting hydrocarbon feedstock (6);
feeding a cocurrent gas-solid downflow fluidized bed reactor (3) via the mixing chamber (2) with a mixture comprising catalyst particles and hydrocarbon feedstock, the cocurrent gas-solid downflow fluidized bed reactor (3) comprising an internal wall; and
at least partially cracking the hydrocarbon feedstock (6) in the presence of the catalyst particles in the cocurrent gas-solid downflow fluidized bed reactor (3), to produce an effluent (10) comprising at least partially coked catalyst and gaseous cracking products;
wherein the internal wall of the mixing chamber (2) and/or of the cocurrent gas-solid downflow fluidized bed reactor (3) comprises a plurality of obstacles (9).
